(19) United States
(12) Patent Application Publication
(10) Pub. No.: US 2025/0299165 A1
(43) Pub. Date: Sep. 25, 2025

(54) METHOD AND SYSTEM FOR ARTIFICIAL INTELLIGENCE DYNAMIC PRICING RECOMMENDATION MODEL FOR CROSS-BORDER TRANSACTIONS

(71) Applicant: Mastercard International Incorporated, Purchase, NY (US)

(72) Inventors: Akash CHOUDHARY, New Delhi (IN); Deepak Yadav, Gurgaon (IN); Garima Arora, Delhi (IN)

(73) Assignee: Mastercard International Incorporated, Purchase, NY (US)

(21) Appl. No.: 18/609,256

(22) Filed: Mar. 19, 2024

(51) Int. Cl. G06Q 20/06

(52) U.S. Cl. CPC G06Q 20/065; G06Q 2220/00

(57) ABSTRACT

A method for real-time fee determination for cross-border transactions includes: receiving, by a receiver of a processing server, a fee request for a cross-border transaction between a first geographic area and a second geographic area; determining, by a processor of the processing server, a fee rate for each of a plurality of alternative currencies for a proposed transaction using a respective alternative currency between the first geographic area and the second geographic area; determining, by the processor of the processing server, a proposed interchange fee for the cross-border transaction based on at least the determined fee rate for one or more of the plurality of alternative currencies; and transmitting, by a transmitter of the processing server, the proposed interchange fee in response to the received fee request.

### FIELD

The present disclosure relates to fee determinations for cross-border transactions, specifically the use of artificial intelligence to determine interchange fees for a cross-border transaction based on fee rates for alternative currencies.

### BACKGROUND

Over a billion payment transactions are conducted throughout the world every day. Transactions that utilize a network to facilitate the transaction typically incur a fee, which is often based on an amount or other aspect of the transaction. Many transactions involve a payment from one party to another using a single currency. However, in some cases a payer is interested in paying using a first currency, while the recipient is interested in being paid in a second currency. These types of transactions are known as “cross-border” transactions, due to such transactions originally occurring between businesses located in different geographic areas that utilize different fiat currencies or between a traveler in a new country desiring to use a payment instrument that is tied to a fiat currency not natively used in that new country. With the Internet and other available forms of communication, cross-border transactions now occur in a variety of additional circumstances, but still involve a payer using a first currency and the payee using a second currency.

In traditional cross-border payment transactions that utilize fiat currencies, the interchange fees for such a transaction are often manually determined by the network facilitating the payment and use a well-defined set of rules. As the familiarity and use of cryptographic currencies, tracked and transferred using blockchains, increases, some cryptographic currencies have been utilized as an alternative for cross-border transactions, where the cryptographic currency can be exchanged for each fiat currency for the respective party and transferred using a blockchain. Under the differing circumstances of use, some cryptographic currencies facilitate cross-border transactions for a significantly lower fee than offered by traditional payment processing networks.

However, while the use of cryptographic currencies has increased, their use is still unfamiliar and difficult for many consumers and is often less convenient and secure than traditional payment transactions that use fiat currencies, and are without the advantages that are often provided by traditional payment networks, such as fraud tools, consumer protections, etc. Thus, there is a need for a technological improvement to existing processes for cross-border payment transactions to provide for competitive interchange fees based on fees for all available currency options to deliver economic benefit to consumers while maintaining a high level of security and value added services to transactions.

### SUMMARY

The present disclosure provides a description of systems and methods for real-time fee determination for cross-border transactions. A processing server can receive a fee request for a cross-border transaction that takes place between two geographic areas. The processing server can identify all alternative currencies that can be used to facilitate the cross-border transaction and identify the fee rate charged by each of the alternative currencies for the requested transaction. The processing server can then determine a proposed interchange fee for the cross-border transaction that is based on the fee rates for the alternative currencies, which can be provided in response to the fee request. In exemplary embodiments, the determinations can be performed in real-time at the time when the cross-border transaction is to occur to provide for an accurate, up-to-date fee proposal, and can utilize a combination of artificial intelligence and a machine learning model to determine a favorable and even the best possible interchange fee that takes into account the stability, security, and added benefits of each of the alternative currencies as compared to standard processing using fiat currencies. The result is a technological system that provides for pricing and processing of cross-border transactions in a way that can stay competitive for consumers against alternative currencies while enabling the security, stability, and additional value of traditional payment transaction processing.

A method for real-time fee determination for cross-border transactions includes: receiving, by a receiver of a processing server, a fee request for a cross-border transaction between a first geographic area and a second geographic area; determining, by a processor of the processing server, a fee rate for each of a plurality of alternative currencies for a proposed transaction using a respective alternative currency between the first geographic area and the second geographic area; determining, by the processor of the processing server, a proposed interchange fee for the cross-border transaction based on at least the determined fee rate for one or more of the plurality of alternative currencies; and transmitting, by a transmitter of the processing server, the proposed interchange fee in response to the received fee request.

A system for real-time fee determination for cross-border transactions includes: a processing server including a receiver receiving a fee request for a cross-border transaction between a first geographic area and a second geographic area, a processor determining a fee rate for each of a plurality of alternative currencies for a proposed transaction using a respective alternative currency between the first geographic area and the second geographic area, and a proposed interchange fee for the cross-border transaction based on at least the determined fee rate for one or more of the plurality of alternative currencies, and a transmitter transmitting the proposed interchange fee in response to the received fee request.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for real-time fee determinations for cross-border transactions in accordance with exemplary embodiments.

FIG. 2 is a block diagram illustrating the processing server in the system of FIG. 1 for real-time fee determinations for cross-border transactions in accordance with exemplary embodiments.

FIG. 3 is a flow diagram illustrating a process for real-time fee determinations for cross-border transactions in the system of FIG. 1 in accordance with exemplary embodiments.

FIG. 4 is a flow chart illustrating an exemplary method for real-time fee determinations for cross-border transactions in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### System for Real-Time Fee Determinations for Cross-Border Transactions

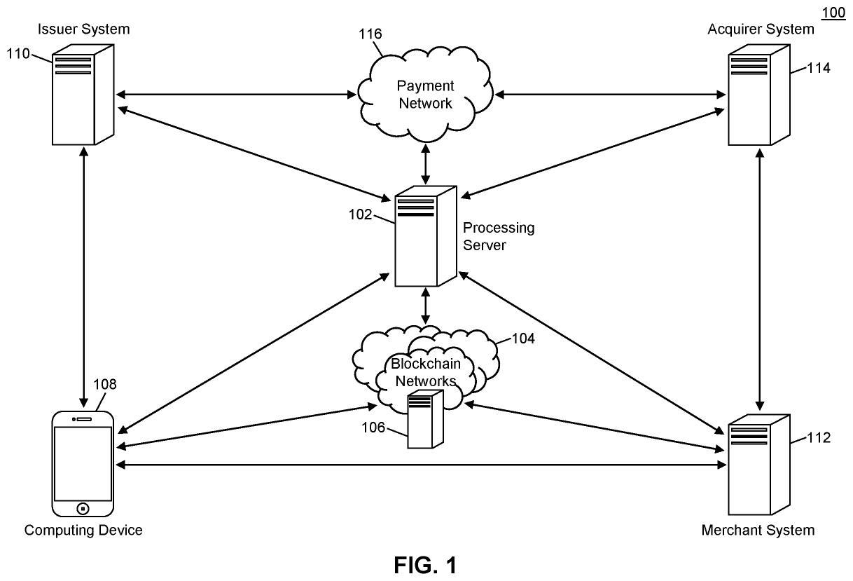

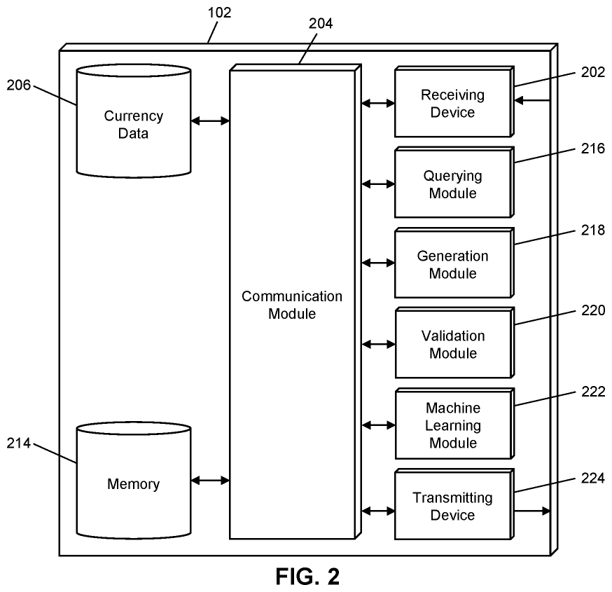

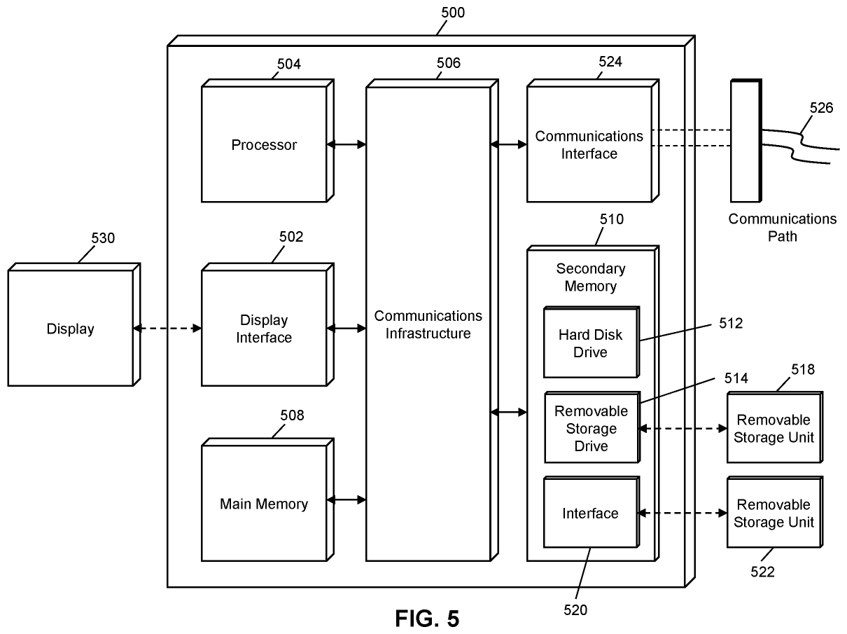

FIG. 1 illustrates a system 100 for the real-time determination of interchange fees for cross-border transactions based on fee rates for alternative currencies. The system 100 can include a processing server 102. The processing server 102, discussed in more detail below, can be a computing system, such as illustrated in FIG. 2 or 5, discussed in more detail below, that is configured to make real-time pricing recommendations for interchange fees based on fees of alternative currencies for cross-border transactions, which can be done utilizing artificial intelligence and machine learning. In the system 100, alternative currencies can include cryptographic currencies that are tracked, transferred, and maintained through blockchain networks 104. Each blockchain network 104 can be comprised of a plurality of blockchain nodes 106. Each blockchain node 106 can be a computing system, such as illustrated in FIG. 5, discussed in more detail below, that is configured to perform functions related to the processing and management of the blockchain, including the generation of blockchain data values, verification of proposed blockchain transactions, verification of digital signatures, generation of new blocks, validation of new blocks, and maintenance of a copy of the blockchain.

A blockchain can be a distributed ledger that is comprised of at least a plurality of blocks. Each block can include at least a block header and one or more data values. Each block header can include at least a timestamp, a block reference value, and a data reference value. The timestamp can be a time at which the block header was generated and can be represented using any suitable method (e.g., UNIX timestamp, DateTime, etc.). The block reference value can be a value that references an earlier block (e.g., based on timestamp) in the blockchain. In some embodiments, a block reference value in a block header can be a reference to the block header of the most recently added block prior to the respective block. In an exemplary embodiment, the block reference value can be a hash value generated via the hashing of the block header of the most recently added block. The data reference value can similarly be a reference to the one or more data values stored in the block that includes the block header. In an exemplary embodiment, the data reference value can be a hash value generated via the hashing of the one or more data values. For instance, the block reference value can be the root of a Merkle tree generated using the one or more data values.

The use of the block reference value and data reference value in each block header can result in the blockchain being immutable. Any attempted modification to a data value would require the generation of a new data reference value for that block, which would thereby require the subsequent block's block reference value to be newly generated, further requiring the generation of a new block reference value in every subsequent block. This would have to be performed and updated in every single blockchain node 106 in a blockchain network 104 prior to the generation and addition of a new block to the blockchain in order for the change to be made permanent. Computational and communication limitations can make such a modification exceedingly difficult, if not impossible, thus rendering the blockchain immutable.

In some embodiments, the blockchain can be used to store information regarding blockchain transactions conducted between two different blockchain wallets. A blockchain wallet can include a private key of a cryptographic key pair that is used to generate digital signatures that serve as authorization by a payer for a blockchain transaction, where the digital signature can be verified by the respective blockchain network 104 using the public key of the cryptographic key pair. In some cases, the term “blockchain wallet” can refer specifically to the private key. In other cases, the term “blockchain wallet” can refer to a computing device (e.g., computing device 108) that stores the private key for use thereof in blockchain transactions. For instance, each computing device can each have their own private key for respective cryptographic key pairs and can each be a blockchain wallet for use in transactions with the blockchain associated with the blockchain network. Computing devices can be any type of device suitable to store and utilize a blockchain wallet, such as a desktop computer, laptop computer, notebook computer, tablet computer, cellular phone, smart phone, smart watch, smart television, wearable computing device, implantable computing device, etc.

Each blockchain data value stored in the blockchain can correspond to a blockchain transaction or other storage of data, as applicable. A blockchain transaction can consist of at least: a digital signature of the sender of that is generated using the sender's private key, a blockchain address of the recipient of currency generated using the recipient's public key, and a blockchain currency amount that is transferred or other data being stored. In some blockchain transactions, the transaction can also include one or more blockchain addresses of the sender where blockchain currency is currently stored (e.g., where the digital signature proves their access to such currency), as well as an address generated using the sender's public key for any change that is to be retained by the sender. Addresses to which cryptographic currency has been sent that can be used in future transactions are referred to as “output” addresses, as each address was previously used to capture output of a prior blockchain transaction, also referred to as “unspent transactions,” due to there being currency sent to the address in a prior transaction where that currency is still unspent. In some cases, a blockchain transaction can also include the sender's public key, for use by an entity in validating the transaction. For the traditional processing of a blockchain transaction, such data can be provided to a blockchain node 106 in a blockchain network 104, either by the sender or the recipient. The node can verify the digital signature using the public key in the cryptographic key pair of the sender's wallet and also verify the sender's access to the funds (e.g., that the unspent transactions have not yet been spent and were sent to address associated with the sender's wallet), a process known as “confirmation” of a transaction, and then include the blockchain transaction in a new block. The new block can be validated by other blockchain nodes 106 in the blockchain network 104 before being added to the blockchain and distributed to all of the blockchain nodes 106 in the blockchain network 104, respectively, in traditional blockchain implementations. In cases where a blockchain data value cannot be related to a blockchain transaction, but instead the storage of other types of data, blockchain data values can still include or otherwise involve the validation of a digital signature.

The system 100 can include a computing device 108. As used herein, the computing device 108 can refer to a physical computing device, such as a desktop computer, laptop computer, notebook computer, tablet computer, cellular phone, smart phone, smart watch, smart television, wearable computing device, etc., and can also refer to a user of the computing device 108 or other entity associated with the computing device 108 that can participate in an electronic payment transaction.

In the system 100, the computing device 108 can be issued a transaction account for use in funding payment transactions by an issuer system 110. A transaction account can be a financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc. The issuer system 110 can refer to an issuer and/or any computing system utilized by or on behalf of the issuer that is used to perform functions for the issuer as discussed herein. An issuer can be any entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

The computing device 108 can be issued payment details for the transaction account to be presented during the initiation of a payment transaction to indicate that the associated transaction account is to be used to fund the payment transaction. The payment details can include a payment account number and any other additional data used in the authentication and verification of the transaction account, such as a name, zip code, billing address, expiration date, security code, etc. In some cases, the entity associated with the computing device 108 can be issued a physical payment card that displays and/or is encoded with the payment details. In other instances, the computing device 108 can be provided with the payment details electronically, such as via e-mail, an application program, a web page, etc.

In the system 100, the computing device 108 can be interested in conducting a an electronic payment transaction with a merchant system 112. As discussed herein, merchant system 112 can refer to the merchant as well as any computing device or system used by or on behalf of the merchant in the performance of functions discussed herein. The merchant system 112 can be associated with any entity that provides products in exchange for currency through payment transactions. The merchant system 112 can be issued a transaction account by an acquirer system 114 that can be used to receive payment as a result of successfully processed payment transactions. As used herein, the acquirer system 114 can refer to an acquirer and/or any computing devices or systems used by or on behalf of the acquirer for performing the functions of the acquirer system 114 discussed herein. An acquirer can be any entity that may process payment card transactions on behalf of a merchant. The acquirer may be a bank or other financial institution authorized to process payment card transactions on a merchant's behalf. In many instances, the acquirer may open a line of credit with the merchant acting as a beneficiary. The acquirer may exchange funds with an issuer in instances where a consumer, which may be a beneficiary to a line of credit offered by the issuer, transacts via a payment card with a merchant that is represented by the acquirer.

In a traditional payment transaction, the consumer via a computing device 108 can initiate the payment transaction with the merchant system 112 by selecting products for purchase and providing payment details for their transaction account to the merchant system 112, such as via a web page, an application program, or at a point of sale at a physical location of the merchant system 112. The merchant system 112 can receive the payment details and submit the payment details as well as additional transaction data values for the payment transaction to the acquirer system 114 using any suitable communication network and method. Additional transaction data values can include any additional data associated with the transaction used in the processing of the payment transaction as well as any functions discussed herein.

Transaction data values can include, for example, transaction amount, transaction time, transaction data, merchant identifier, bank identification number, point of sale identifier, currency type, exchange rate, payment method, product data, reward data, offer data, coupon data, etc. The acquirer system 114 can receive the transaction data from the merchant system 112, which can include the payment details and the additional transaction data values and submit an authorization request to a payment network 116 for processing.

The payment network 116 can be a system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by Mastercard®, VISA® Discover®, American Express®, PayPal®, etc. Use of the term “payment network” herein may refer to both the payment network as an entity, and the physical payment network, such as the equipment, hardware, and software comprising the payment network. As used herein, “payment rails” can refer to the network infrastructure used to transmit transaction messages to and from the payment network 116.

The payment network 116 can receive the authorization request from the acquirer system 114 and process the authorization request using traditional methods. An authorization request can be a specific type of transaction message that indicates a payment transaction needs to be authorized by the issuer system 110 that issued the transaction account as well as any other applicable entity, such as to ensure compliance of the payment transaction with any applicable rules or regulations and to ensure that the transaction account selected for use in funding the payment transaction by the consumer 108 has sufficient funding and/or credit to cover the transaction amount for the payment transaction. A transaction message can be a specially formatted data message that is formatted pursuant to one or more standards governing the exchange of financial transaction messages, such as the International Organization of Standardization's ISO 8583 or ISO 20022 standards. A transaction message can include a plurality of data elements, where each element can store transaction data values as indicated in the applicable standard, as well as other data as indicated in the applicable standard. An authorization request can be indicated via a message type indicator of the transaction message that indicates that the transaction message is an authorization request.

In a traditional payment transaction, the payment network 116 can perform any added services as part of the processing of the payment transaction for which the authorization request is received, such as fraud scoring, and forward the authorization request to the issuer system 110, which can be identified via the payment account number (e.g., via a bank identification number or other value included therein) or other data included in the additional transaction data values included in the received authorization request. The issuer system 110 can receive the authorization request and determine whether or not to approve the payment transaction, such as based on the available funding and/or credit of the transaction account associated with the payment account number to cover the transaction amount for the payment transaction, as well as compliance with any applicable controls. The issuer system 110 can provide an authorization response back to the payment network 116 using the payment rails that includes a data element that includes a response code indicating approval or decline of the payment transaction. The authorization response can include a message type indicator indicative of an authorization response. In some cases, the authorization response can be a modified authorization request. In other cases, the authorization response can be a newly generated transaction message.

The payment network 116 can receive the authorization response from the issuer system 110 and forward the authorization response to the acquirer system 114 using the payment rails of the payment network 116. The acquirer system 114 can provide the authorization response or at least an indication of approval or decline of the payment transaction based thereon to the merchant system 112. The merchant system 112 can then finalize the payment transaction, such as by informing the consumer 108 of a decline by the issuer system 110 and preventing purchase of the selected products or by providing the consumer 108 with the selected products as well as a receipt or other information regarding the approved payment transaction.

In the system 100, the electronic payment transaction that the computing device 108 is interested in conducting with the merchant system 112 can be a cross-border transaction. The electronic payment transaction can be a cross-border transaction due to involving two different geographic locations. The geographic locations can be physical locations of the computing device 108 and the merchant system 112, such as where the computing device 108 is in a first country and the merchant system 112 is in a second country where communication regarding the proposed transaction utilizes the Internet or other method. In some cases, the geographic locations can refer to geographic locations of the transaction accounts to be used by the computing device 108 and merchant system 112, which can be specified as part of the details of the transaction accounts themselves of the entities that issued the transaction accounts (e.g., the issuer system 110 and acquirer system 114). In some instances, geographic location can be determined based on the currency that is used by the transaction account. For instance, the transaction account selected for use by the computing device 108 for the proposed transaction can be held in United States dollars while the transaction account selected for use by the merchant system 112 can be held in South African rand.

Traditionally, the computing device 108 can provide payment details to the merchant system 112 using traditional methods (e.g., presentation and reading of a physical payment card, near field communication transmission from a payment card or the computing device 108, transmission of payment details over the Internet, etc.), and the merchant system 112 can submit the transaction to the acquirer system 114, where an authorization request can be submitted to the payment network 116 for processing. In such cases, the payment network 116 can impose an interchange fee for the cross-border transaction, which can be paid by the issuer system 110, paid by the computing device 108, or paid by the issuer system 110 on behalf of the computing device 108 where the interchange fee is debited from the transaction account used by the computing device 108 in addition to the transaction amount for the cross-border transaction. In an example, the cross-border transaction can be for an amount of $100 paid to the merchant system 112, which will be received by the merchant system as R1,832 (e.g., based on an exchange rate of R18.32 to $1), where the computing device 108 can be charged $108 due to an interchange fee of $8 (e.g., as a flat rate of $8, a rate of 8% of the transaction amount, etc.).

In the system 100, blockchain networks 104 can provide for cross-border transactions for computing devices 108 and merchant systems 112 that utilize alternative cryptographic currencies to facilitate the cross-border transaction. In the above example, the computing device 108 can be interested in purchasing a product from the merchant system 112 for $100. A first blockchain network 104 can utilize a first cryptographic currency for the cross-border transaction for a fee of $2, in order to entice the computing device 108 to utilize the blockchain network 104 instead of the payment network 116 for the transaction. In order to process the transaction, the computing device 108 can pay the $102 to a transaction account indicated by the first blockchain network 104, the blockchain network 104 can transfer an applicable amount of the first cryptographic currency from a first blockchain wallet associated with the United States dollar to a second blockchain wallet associated with the South African rand, and the blockchain network 104 can pay R1,832 to the merchant system 112 from a suitable transaction account. In some cases, the blockchain network 104 can require the computing device 108 to exchange the $102 for an applicable amount of the first cryptographic currency that is transferred to a blockchain wallet on the first blockchain for the computing device 108 and transfer an equivalent of $100 to a blockchain wallet of the merchant system 112 on the first blockchain with the $2 fee being transferred to an appropriate blockchain wallet (e.g., of a blockchain miner that facilitates the blockchain transaction), where the merchant system 112 can then exchange the received amount of first cryptographic currency for R1,832. Other methods for facilitating a cross-border transaction via the use of cryptographic currencies as alternatives to fiat currencies can be used as applicable, where the computing device 108 or other participant can be charged a fee for the transaction. In some cases, fees charged by blockchains for cross-border transactions can be referred to as “gas” fees.

Prior to conducting their desired cross-border transaction, the computing device 108 can request a proposed interchange fee to be charged by the payment network 116 for processing the cross-border transaction via the payment network 116 using traditional payment rails and transaction processing. In order to provide for a better fee than via traditional methods, the payment network 116 can request that the processing server 102 provide a recommended interchange fee. In some embodiments, the processing server 102 can be a component in the payment network 116, where a fee request can be submitted by the computing device 108 to the payment network 116 and routed to the processing server 102 using internal communication methods. In other embodiments, the processing server 102 can be separate from the payment network 116 and provided the fee request by the payment network 116 using the payment rails or other suitable communication method. In some cases, the computing device 108 can submit a fee request directly to the processing server 102, which can determine the proposed interchange fee and provide the proposed fee to the computing device 108 and to the payment network 116. In other cases, the processing server 102 can receive a fee request by any component in the system 100 that is participating in the cross-border transaction.

The processing server 102 can receive a fee request to initiate a process to determine a proposed interchange fee for the proposed cross-border transaction that is based on fee rates provided by the plurality of blockchain networks 104 that can offer to facilitate the cross-border transaction using their respective cryptographic currencies. The fee request can include at least the two geographic areas (e.g., or associated fiat currencies) involved in the proposed cross-border transaction and can include any other transaction data suitable for performing the functions discussed herein. The processing server 102 can then identify the fee rates for each cryptographic currency that can be used to facilitate the cross-border transaction. The fee rates can be determined via requests for such data by the processing server 102 from blockchain nodes 106 associated with each cryptographic currency, based on actual fees paid for cross-border transactions involving the same geographic areas, based on actual fees paid for cross-border transactions involving one of the two geographic areas, based on fee data published or otherwise made available by the blockchain networks 104 associated with each cryptographic currency, etc. In cases where the fee rates can vary based on the transaction amount or other transaction data, the processing server 102 can utilize the additional transaction data included in the fee request accordingly.

In an exemplary embodiment, the processing server 102 can determine the proposed interchange fee in real-time. In such embodiments, the processing server 102 can newly determine the fee rates for each alternative currency upon receipt of the fee request, such as to ensure the latest, most up-to-date fee rates, exchange rates, and other data are used. In some embodiments, the processing server 102 can use a combination of artificial intelligence and machine learning to determine the proposed interchange fee. In these embodiments, an artificial intelligence engine can be utilized by the processing server 102 in determining proposed interchange fees. The artificial intelligence can use a machine learning model that collects data regarding published fee rates, offered fee rates, paid interchange fees, exchange rates, and other data to train the machine learning model that can be continually retrained as data is collected. Each time a new cross-border transaction is processed, by the payment network 116 or blockchain networks 104, applicable transaction data can be input into the machine learning model and the machine learning model retrained such that the machine learning model can always provide an accurate and effective interchange fee in real-time as requested. The artificial intelligence engine can select and use data for use in training the machine learning model and for the determination of an interchange fee based on additional criteria, such as operating costs of the payment network 116, exchange rates, etc.

In some cases, stability and security of each alternative currency can be taken into account in the determination of a proposed interchange fee. In one such case, the processing server 102 can only utilize fee rates for cryptographic currencies that are considered stable as determined by a suitable metric (e.g., number of transactions, amount of cryptographic currency in circulation, change in valuation, etc.). In another case, the processing server 102 can weigh the effect of the fee rate for each cryptographic currency in determining the proposed interchange fee based on the stability of the respective cryptographic currency or other criteria. In some such cases, stability can be based on the number of transactions involving the cryptographic currency, the number of cross-border transactions facilitated using that cryptographic currency involving one or both of the geographic areas, the number of transactions of at least the transaction amount for the proposed cross-border transaction in equivalent of the cryptographic currency, a combination of such criteria, etc. In some instances, the proposed interchange fee can be determined to be higher than the fee rates for one or more of the alternative currencies due to value provided by the security and other value added services of the payment network 116. In such instances, the value can be represented when providing the proposed interchange fee to the computing device 108 or other entity.

Once the processing server 102 has determined the proposed interchange fee, the processing server 102 can respond to the fee request with the proposed interchange fee. In cases where the computing device 108 has submitted the fee request, the processing server 102 can provide the proposed interchange fee to the computing device 108, which can then display the proposed interchange fee to a user thereof. The user can then determine whether or not to proceed with the cross-border transaction using the payment network 116 for the proposed fee or use an alternative currency. In cases where the payment network 116 has submitted the fee request, the processing server 102 can provide the proposed interchange fee to the payment network 116, which can be used thereby when charging the interchange fee for the cross-border transaction.

In some embodiments, the fee request can be included in the authorization request submitted for the cross-border transaction, such as can be indicated in a specific data value, such as a data element reserved for private use. In such embodiments, the processing server 102 can receive the authorization request from the payment network 116 or acquirer system 114. The processing server 102 can determine the proposed interchange fee in real-time and include the proposed interchange fee in a suitable data value included in the authorization request, such as a data element reserved for private use, which can replace the fee request or be included in the authorization request in addition to the fee request. In some such embodiments, the interchange fee can be charged based on the included proposed interchange fee. In other such embodiments, the authorization request can be forwarded to the issuer system 110 using the payment rails, where the issuer system 110 can use the proposed interchange fee as part of the determination whether to approve or decline the payment transaction. For instance, the issuer system 110 can decline the payment transaction if the proposed interchange fee is unacceptable, such as based on prior indication given by the computing device 108. In another instance, the issuer system 110 can transmit the proposed interchange fee parsed from the authorization request to the computing device 108, which can prompt a user to accept the proposed interchange fee or decline the payment transaction. This can provide for the ability for the computing device 108 to identify and accept the proposed interchange fee without requiring any additional action prior to the cross-border transaction.

The methods and systems discussed herein provide for real-time determination of interchange fees for cross-border transactions. By utilizing fee rates for alternative currencies, the processing server 102 can determine an interchange fee for a cross-border transaction that is still beneficial to consumers while being suitably acceptable for the payment network 116 that is to process the cross-border transaction. The use of artificial intelligence and machine learning can further strengthen the competitiveness of the proposed fee without detriment to the payment network 116, resulting in a system that can improve and may even maximize economic benefit to participants while also providing maximized benefit in other transactional services provided by payment networks 116 over processes of alternative currencies.

### Processing Server

FIG. 2 illustrates an embodiment of the processing server 102 in the system 100 of FIG. 1. It will be apparent to persons having skill in the relevant art that the embodiment of the processing server 102 illustrated in FIG. 2 is provided as illustration only and cannot be exhaustive to all possible configurations of the processing server 102 suitable for performing the functions as discussed herein. For example, the computer system 500 illustrated in FIG. 5 and discussed in more detail below can be a suitable configuration of the processing server 102.

The processing server 102 can include a receiving device 202. The receiving device 202 can be configured to receive data over one or more networks via one or more network protocols. In some instances, the receiving device 202 can be configured to receive data from blockchain nodes 106, computing devices 108, issuer systems 110, merchant systems 112, acquirer systems 114, payment networks 116, and other systems and entities via one or more communication methods, such as radio frequency, local area networks, wireless area networks, cellular communication networks, Bluetooth, the Internet, etc. In some embodiments, the receiving device 202 can be comprised of multiple devices, such as different receiving devices for receiving data over different networks, such as a first receiving device for receiving data over a local area network and a second receiving device for receiving data via the Internet. The receiving device 202 can receive electronically transmitted data signals, where data can be superimposed or otherwise encoded on the data signal and decoded, parsed, read, or otherwise obtained via receipt of the data signal by the receiving device 202. In some instances, the receiving device 202 can include a parsing module for parsing the received data signal to obtain the data superimposed thereon. For example, the receiving device 202 can include a parser program configured to receive and transform the received data signal into usable input for the functions performed by the processing device to carry out the methods and systems described herein.

The receiving device 202 can be configured to receive data signals that are superimposed or otherwise encoded with fee requests, which can be electronically transmitted by computing devices 108, issuer systems 110, merchant systems 112, acquirer systems 114, or payment networks 116. The receiving device 202 can also be configured to receive data signals superimposed or otherwise encoded with transaction messages, including authorization requests and authorization responses, that can be electronically transmitted by issuer systems 110, merchant systems 112, acquirer systems 114, or payment networks 116. The receiving device 202 can also be configured to receive data signals that are superimposed or otherwise encoded with fee rates and other data related to transaction fees, which can be electronically transmitted by blockchain nodes 106, payment networks 116, and other suitable entities.

The processing server 102 can also include a communication module 204. The communication module 204 can be configured to transmit data between modules, engines, databases, memories, and other components of the processing server 102 for use in performing the functions discussed herein. The communication module 204 can be comprised of one or more communication types and utilize various communication methods for communications within a computing device. For example, the communication module 204 can be comprised of a bus, contact pin connectors, wires, etc. In some embodiments, the communication module 204 can also be configured to communicate between internal components of the processing server 102 and external components of the processing server 102, such as externally connected databases, display devices, input devices, etc. The processing server 102 can also include a processing device. The processing device can be configured to perform the functions of the processing server 102 discussed herein as will be apparent to persons having skill in the relevant art. In some embodiments, the processing device can include and/or be comprised of a plurality of engines and/or modules specially configured to perform one or more functions of the processing device, such as a querying module 216, generation module 218, validation module 220, machine learning module 222, etc. As used herein, the term “module” can be software or hardware particularly programmed to receive an input, perform one or more processes using the input, and provides an output. The input, output, and processes performed by various modules will be apparent to one skilled in the art based upon the present disclosure.

The processing server 102 can also include currency data 206, which can be stored in a memory 214 of the processing server 102 or stored in a separate area within the processing server 102 or accessible thereby. The currency data 206 can include data associated with one or more fiat currencies, cryptographic currencies, and any other alternative currencies that can be used to facilitate cross-border transactions. Currency data 206 can include, for example, currency names, associated payment networks 116, associated blockchain networks 104, exchange rates, fee data, transaction histories, etc.

The processing server 102 can also include a memory 214. The memory 214 can be configured to store data for use by the processing server 102 in performing the functions discussed herein, such as public and private keys, symmetric keys, etc. The memory 214 can be configured to store data using suitable data formatting methods and schema and can be any suitable type of memory, such as read-only memory, random access memory, etc. The memory 214 can include, for example, encryption keys and algorithms, communication protocols and standards, data formatting standards and protocols, program code for modules and application programs of the processing device, and other data that can be suitable for use by the processing server 102 in the performance of the functions disclosed herein as will be apparent to persons having skill in the relevant art. In some embodiments, the memory 214 can be comprised of or can otherwise include a relational database that utilizes structured query language for the storage, identification, modifying, updating, accessing, etc. of structured data sets stored therein. The memory 214 can be configured to store, for example, device profiles, device profile data, configuration keys, cryptographic keys including public keys and/or private keys, communication data, encryption algorithms, etc.

The processing server 102 can include a querying module 216. The querying module 216 can be configured to execute queries on databases to identify information. The querying module 216 can receive one or more data values or query strings and can execute a query string based thereon on an indicated database, such as the currency data 206 of the processing server 102 to identify information stored therein. The querying module 216 can then output the identified information to an appropriate engine or module of the processing server 102 as necessary. The querying module 216 can, for example, execute a query on the currency data 206 to identify fee rates for alternative currencies for two geographic locations as included in a fee request received by the receiving device 202.

The processing server 102 can also include a generation module 218. The generation module 218 can be configured to generate data for use by the processing server 102 in performing the functions discussed herein. The generation module 218 can receive instructions as input, can generate data based on the instructions, and can output the generated data to one or more modules of the processing server 102. For example, the generation module 218 can be configured to generate interchange fees, response messages, transaction messages, data request messages, etc.

The processing server 102 can also include a validation module 220. The validation module 220 can be configured to perform data validations and verifications for the processing server 102 as part of the functions discussed herein. The validation module 220 can receive instructions as input, can perform data validations or verification as instructed, and can output a result of the data validations or verifications to one or more modules of the processing server 102. In some cases, the input can include the data to be validated or verified and/or data to be used in the validation or verification. In other cases, the validation module 220 can be configured to identify such data, such as in the currency data 206 and/or memory 214. The validation module 220 can be configured to, for example, validate received data (e.g., fee requests, fee rates, exchange rates, etc.), authenticate communications, verify transaction data, etc.

The processing server 102 can also include a machine learning module 222. The machine learning module 222 can be configured to train machine learning models and use machine learning models for the processing server 102 as part of the functions discussed herein. The machine learning module 222 can receive instructions as input, can perform functions related to machine learning as instructed, and can output a result of the functions to one or more modules of the processing server 102. In some cases, the input can include data to be used, such as the machine learning model, data for use in training the model, data for use in applying the model, etc. In other cases, the machine learning module 222 can be configured to identify such data, such as in the currency data 206 and/or memory 214. The machine learning module 222 can be configured to train a machine learning model, retrain a machine learning model, applying data to a machine learning model, use a machine learning model to determine a proposed interchange fee for a cross-border transaction based on fee rates for alternative currencies, and be utilized by an artificial intelligence engine in performing the functions discussed herein.

The processing server 102 can also include a transmitting device 224. The transmitting device 224 can be configured to transmit data over one or more networks via one or more network protocols. In some instances, the transmitting device 224 can be configured to transmit data to blockchain nodes 106, computing devices 108, issuer systems 110, merchant systems 112, acquirer systems 114, payment networks 116, and other entities via one or more communication methods, local area networks, wireless area networks, cellular communication, Bluetooth, radio frequency, the Internet, etc. In some embodiments, the transmitting device 224 can be comprised of multiple devices, such as different transmitting devices for transmitting data over different networks, such as a first transmitting device for transmitting data over a local area network and a second transmitting device for transmitting data via the Internet. The transmitting device 224 can electronically transmit data signals that have data superimposed that can be parsed by a receiving computing device. In some instances, the transmitting device 224 can include one or more modules for superimposing, encoding, or otherwise formatting data into data signals suitable for transmission.

The transmitting device 224 can be configured to electronically transmit data signals that can be superimposed or otherwise encoded with proposed interchange fees and other response messages to fee requests to computing devices 108, issuer systems 110, merchant systems 112, acquirer systems 114, and payment networks 116. The transmitting device 224 can also be configured to electronically transmit data signals superimposed or otherwise encoded with transaction messages, including authorization requests and authorization responses, to issuer systems 110, merchant systems 112, acquirer systems 114, and payment networks 116. The transmitting device 224 can also be configured to electronically transmit data signals that are superimposed or otherwise encoded with data request messages to computing devices 108, issuer systems 110, merchant systems 112, acquirer systems 114, and payment networks 116.

### Process for Real-Time Determination of Interchange Fees

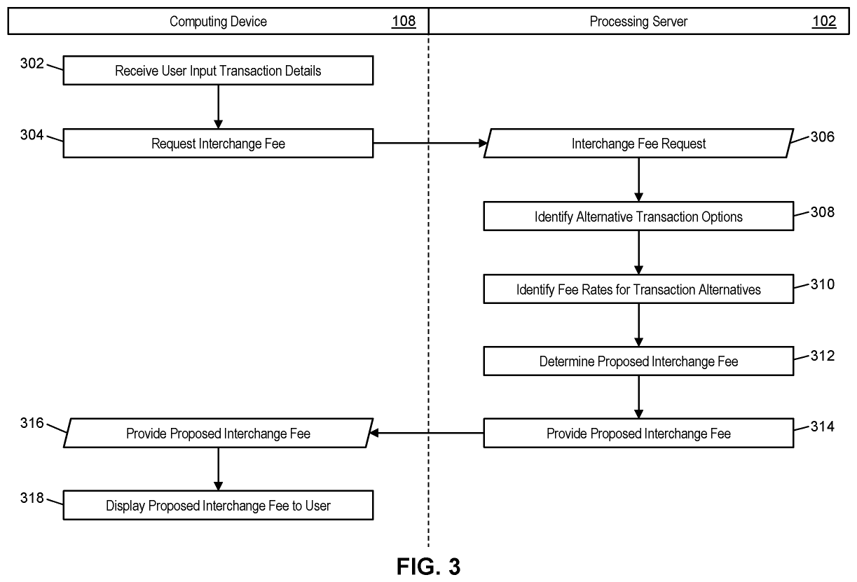

FIG. 3 illustrates a process in the system 100 of FIG. 1 for the real-time determination of a proposed interchange fee for a cross-border transaction based on fee rates of alternative currencies. The process illustrated in FIG. 3 is for an embodiment where a participant in a proposed cross-border transaction is provided with the proposed interchange fee prior to initiating the transaction. As will be apparent to persons having skill in the relevant art, the methods discussed herein, which can include some or all of the steps in FIG. 3 as performed by the processing server 102 and other components in the system 100, can utilize alternative process flows that can occur before or during processing of the cross-border transaction, as discussed above.

In step 302, the computing device 108 can receive transaction details for a proposed cross-border transaction as input by a user thereof. The transaction details can include at least a first geographic area and second geographic area for the proposed cross-border transaction, which can be represented by a first fiat currency of the transaction account used by the payer (e.g., computing device 108) in the proposed cross-border transaction and a second fiat currency of the transaction account used by the payee (e.g., merchant system 112) in the proposed cross-border transaction, as well as any other transaction data indicated for inclusion in a fee request, such as a transaction amount, merchant identification number, merchant category code, point of sale type, etc. In step 304, the computing device 108 can submit a fee request to the processing server 102 using a suitable communication network and method. The fee request can include the first geographic area, the second geographic area, and any additional transaction data. For instance, in the above example, the fee request can include United States dollar, South African rand, and a transaction amount of $100.

In step 306, the receiving device 202 of the processing server 102 can receive the submitted fee request. In step 308, the querying module 216 of the processing server 102 can execute one or more queries on the currency data 206 and/or memory 214 of the processing server 102 to identify one or more alternative currencies that can be used to facilitate a cross-border transaction involving the first geographic area and the second geographic area. In the above example, the processing server 102 can identify all cryptographic currencies that can be used for cross-border transactions involving the United States dollar and South African rand of $100 and R1,832. In step 310, the querying module 216 of the processing server 102 can execute one or more queries on the currency data 206 and/or memory 214 of the processing server 102 to identify the fee rates for the requested proposed cross-border transaction for each of the identified alternative currencies, where the fee rates can be further based on the additional transaction data. For instance, in the above example, the processing server 102 can identify four cryptographic currencies that can facilitate the $100 transaction to be paid as R1,832 for fees of $3, $3.20, $4, and $5, respectively.

In step 312, the machine learning module 222 of the processing server 102 can utilize a trained machine learning model to determine a proposed interchange fee based on at least the identified fee rates and any other applicable data, such as requirements of the payment network 116, rules and regulations for the first and second geographic areas, etc. In the above example, the machine learning module 222 can determine a proposed interchange fee of $3.35, which can be low enough to be in the lower end of the fee rates for the identified cryptographic currencies while still providing enough fee to cover the costs of the payment network 116 in processing the cross-border transaction. In step 314, the transmitting device 224 of the processing server 102 can electronically transmit the proposed interchange fee to the computing device 108 in response to the fee request using a suitable communication network and method. In some embodiments, the transmitting device 224 of the processing server 102 can also electronically transmit the proposed interchange fee to the payment network 116 and/or issuer system 110, such as to ensure that the proposed interchange fee is applied to the proposed cross-border transaction if accepted by the participant. In some embodiments, the processing server 102 can include the determined fee rates of the alternative currencies and/or any other data used in determining the proposed interchange fee.

In step 316, the computing device 108 can receive the proposed interchange fee. In step 318, the computing device 108 can display the proposed interchange fee to a user thereof. The user can then decide whether to proceed with the proposed cross-border transaction traditionally using the payment network 116 for the proposed interchange fee or use an alternative currency to facilitate the proposed cross-border transaction, such as can be performed via a blockchain network 104. In the above example, the user of the computing device 108 can be presented with the proposed interchange fee of $3.35 as well as the determined fee rates for the four alternative currencies along with an indication of the additional services, such as fraud scoring, consumer protection, etc. that are available if the interchange fee of $3.35 is accepted. In some embodiments, the user can formally accept the proposed interchange fee via input on the computing device 108 that transmits a message of acceptance to the processing server 102. In some cases, acceptance of the proposed interchange fee can be communicated via the initiation of the proposed cross-border transaction with the payment network 116 following receipt of the proposed interchange fee. In some such cases, the proposed interchange fee can have an applicable time period (e.g., indicated in the response to the fee request) during which the proposed cross-border transaction must be initiated in order to have the proposed interchange fee applied.

### Exemplary Method for Secure Storage of Cybersecurity Data

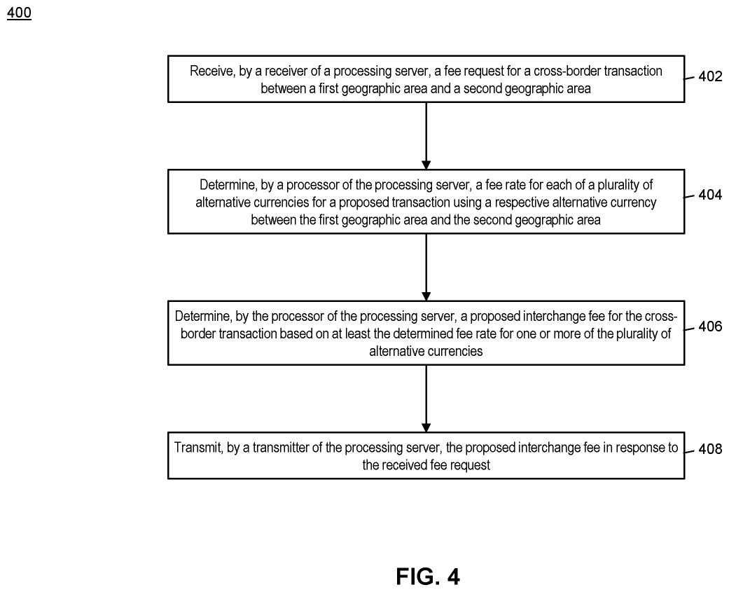

FIG. 4 illustrates a method 400 for the real-time determination of an interchange fee for a cross-border transaction.

In step 402, a fee request for a cross-border transaction between a first geographic area and a second geographic area can be received by a receiver (e.g., receiving device 202) of a processing server (e.g., processing server 102). In step 404, a fee rate can be determined by a processor (e.g., querying module 216) of the processing server for each of a plurality of alternative currencies for a proposed transaction using a respective alternative currency between the first geographic area and the second geographic area.

In step 406, a proposed interchange fee for the cross-border transaction can be determined by the processor (e.g., machine learning module 222) of the processing server based on at least the determined fee rate for one or more of the plurality of alternative currencies. In step 408, the proposed interchange fee can be transmitted by a transmitter (e.g., transmitting device 224) of the processing server in response to the received fee request.

In one embodiment, the method 400 can further include: receiving, by the receiver of the processing server, an acceptance message in response to the transmitted proposed interchange fee; and initiating, by the processor of the processing server (e.g., transmitting device 224), an electronic payment transaction for the cross border transaction, wherein the proposed interchange fee is charged to a participant (e.g., computing device 108) involved in the electronic payment transaction. In a further embodiment, the fee request can be an authorization request for the cross-border transaction, the authorization request can be transmitted in response to the received fee request including the proposed interchange fee, and the acceptance message can be an authorization response. In an even further embodiment, initiating the electronic payment transaction can include forwarding the authorization response.

In some embodiments, the proposed interchange fee can be determined by artificial intelligence using a machine learning model. In one embodiment, the fee request can further include a transaction amount, and determining the fee rate for each of the plurality of alternative currencies can be further based on an equivalent transaction amount for the respective alternative currency based on the transaction amount and an exchange rate with the respective alternative currency. In some embodiments, the cross-border transaction can involve two fiat currencies and each of the plurality of alternative currencies can be a cryptographic currency. In one embodiment, the fee rate for each of the plurality of alternative currencies can be determined in real-time.

### Computer System Architecture

FIG. 5 illustrates a computer system 500 in which embodiments of the present disclosure, or portions thereof, can be implemented as computer-readable code. For example, the processing server 102, blockchain nodes 106, computing device 108, issuer system 110, merchant system 112, and acquirer system 114 can be implemented in the computer system 500 using hardware, non-transitory computer readable media having instructions stored thereon, or a combination thereof and can be implemented in one or more computer systems or other processing systems. Hardware can embody modules and components used to implement the methods of FIGS. 3 and 4.

If programmable logic is used, such logic can execute on a commercially available processing platform configured by executable software code to become a specific purpose computer or a special purpose device (e.g., programmable logic array, application-specific integrated circuit, etc.). A person having ordinary skill in the art can appreciate that embodiments of the disclosed subject matter can be practiced with various computer system configurations, including multi-core multiprocessor systems, minicomputers, mainframe computers, computers linked or clustered with distributed functions, as well as pervasive or miniature computers that can be embedded into virtually any device. For instance, at least one processor device and a memory can be used to implement the above described embodiments.

A processor unit or device as discussed herein can be a single processor, a plurality of processors, or combinations thereof. Processor devices can have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations can be described as a sequential process, some of the operations can in fact be performed in parallel, concurrently, and/or in a distributed environment, and with program code stored locally or remotely for access by single or multi-processor machines. In addition, in some embodiments the order of operations can be rearranged without departing from the spirit of the disclosed subject matter.

Processor device 504 can be a special purpose or a general purpose processor device specifically configured to perform the functions discussed herein. The processor device 504 can be connected to a communications infrastructure 506, such as a bus, message queue, network, multi-core message-passing scheme, etc. The network can be any network suitable for performing the functions as disclosed herein and can include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 can also include a main memory 508 (e.g., random access memory, read-only memory, etc.), and can also include a secondary memory 510. The secondary memory 510 can include the hard disk drive 512 and a removable storage drive 514, such as a floppy disk drive, a magnetic tape drive, an optical disk drive, a flash memory, etc.

The removable storage drive 514 can read from and/or write to the removable storage unit 518 in a well-known manner. The removable storage unit 518 can include a removable storage media that can be read by and written to by the removable storage drive 514. For example, if the removable storage drive 514 is a floppy disk drive or universal serial bus port, the removable storage unit 518 can be a floppy disk or portable flash drive, respectively. In one embodiment, the removable storage unit 518 can be non-transitory computer readable recording media.

In some embodiments, the secondary memory 510 can include alternative means for allowing computer programs or other instructions to be loaded into the computer system 500, for example, the removable storage unit 522 and an interface 520. Examples of such means can include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) can be stored on any type of suitable computer readable media, such as optical storage (e.g., a compact disc, digital versatile disc, Blu-ray disc, etc.) or magnetic tape storage (e.g., a hard disk drive). The data can be configured in any type of suitable database configuration, such as a relational database, a structured query language (SQL) database, a distributed database, an object database, etc. Suitable configurations and storage types will be apparent to persons having skill in the relevant art.

The computer system 500 can also include a communications interface 524. The communications interface 524 can be configured to allow software and data to be transferred between the computer system 500 and external devices. Exemplary communications interfaces 524 can include a modem, a network interface (e.g., an Ethernet card), a communications port, a PCMCIA slot and card, etc. Software and data transferred via the communications interface 524 can be in the form of signals, which can be electronic, electromagnetic, optical, or other signals as will be apparent to persons having skill in the relevant art. The signals can travel via a communications path 526, which can be configured to carry the signals and can be implemented using wire, cable, fiber optics, a phone line, a cellular phone link, a radio frequency link, etc.

The computer system 500 can further include a display interface 502. The display interface 502 can be configured to allow data to be transferred between the computer system 500 and external display 530. Exemplary display interfaces 502 can include high-definition multimedia interface (HDMI), digital visual interface (DVI), video graphics array (VGA), etc. The display 530 can be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium can refer to memories, such as the main memory 508 and secondary memory 510, which can be memory semiconductors (e.g., DRAMs, etc.). These computer program products can be means for providing software to the computer system 500. Computer programs (e.g., computer control logic) can be stored in the main memory 508 and/or the secondary memory 510. Computer programs can also be received via the communications interface 524. Such computer programs, when executed, can enable computer system 500 to implement the present methods as discussed herein. In particular, the computer programs, when executed, can enable processor device 504 to implement the methods illustrated by FIGS. 3 and 4, as discussed herein. Accordingly, such computer programs can represent controllers of the computer system 500. Where the present disclosure is implemented using software, the software can be stored in a computer program product and loaded into the computer system 500 using the removable storage drive 514, interface 520, and hard disk drive 512, or communications interface 524.

The processor device 504 can comprise one or more modules or engines configured to perform the functions of the computer system 500. Each of the modules or engines can be implemented using hardware and, in some instances, can also utilize software, such as corresponding to program code and/or programs stored in the main memory 508 or secondary memory 510. In such instances, program code can be compiled by the processor device 504 (e.g., by a compiling module or engine) prior to execution by the hardware of the computer system 500. For example, the program code can be source code written in a programming language that is translated into a lower level language, such as assembly language or machine code, for execution by the processor device 504 and/or any additional hardware components of the computer system 500. The process of compiling can include the use of lexical analysis, preprocessing, parsing, semantic analysis, syntax-directed translation, code generation, code optimization, and any other techniques that can be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for real-time fee determination for cross-border transactions. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or can be acquired from practicing of the disclosure, without departing from the breadth or scope.

What is claimed is:

1. A method for real-time fee determination for cross-border transactions, comprising:
receiving, by a receiver of a processing server, a fee request for a cross-border transaction between a first geographic area and a second geographic area;
determining, by a processor of the processing server, a fee rate for each of a plurality of alternative currencies for a proposed transaction using a respective alternative currency between the first geographic area and the second geographic area;
determining, by the processor of the processing server, a proposed interchange fee for the cross-border transaction based on at least the determined fee rate for one or more of the plurality of alternative currencies; and
transmitting, by a transmitter of the processing server, the proposed interchange fee in response to the received fee request.

2. The method of claim 1, further comprising:
receiving, by the receiver of the processing server, an acceptance message in response to the transmitted proposed interchange fee; and
initiating, by the processor of the processing server, an electronic payment transaction for the cross-border transaction, wherein the proposed interchange fee is charged to a participant involved in the electronic payment transaction.

3. The method of claim 2, wherein
the fee request is an authorization request for the cross-border transaction,
the authorization request is transmitted in response to the received fee request including the proposed interchange fee, and
the acceptance message is an authorization response.

4. The method of claim 3, wherein initiating the electronic payment transaction includes forwarding the authorization response.

5. The method of claim 1, wherein the proposed interchange fee is determined by artificial intelligence using a machine learning model.

6. The method of claim 1, wherein
the fee request further includes a transaction amount, and
determining the fee rate for each of the plurality of alternative currencies is further based on an equivalent transaction amount for the respective alternative currency based on the transaction amount and an exchange rate with the respective alternative currency.

7. The method of claim 1, wherein the cross-border transaction involves two fiat currencies and each of the plurality of alternative currencies is a cryptographic currency.

8. The method of claim 1, wherein the fee rate for each of the plurality of alternative currencies is determined in real-time.

9. A system for real-time fee determination for cross-border transactions, comprising:
a processing server including
a receiver receiving a fee request for a cross-border transaction between a first geographic area and a second geographic area,
a processor determining
a fee rate for each of a plurality of alternative currencies for a proposed transaction using a respective alternative currency between the first geographic area and the second geographic area, and
a proposed interchange fee for the cross-border transaction based on at least the determined fee rate for one or more of the plurality of alternative currencies, and
a transmitter transmitting the proposed interchange fee in response to the received fee request.

10. The system of claim 9, wherein
the receiver of the processing server receives an acceptance message in response to the transmitted proposed interchange fee, and
the processor of the processing server initiates an electronic payment transaction for the cross-border transaction, wherein the proposed interchange fee is charged to a participant involved in the electronic payment transaction.

11. The system of claim 10, wherein
the fee request is an authorization request for the cross-border transaction,
the authorization request is transmitted in response to the received fee request including the proposed interchange fee, and
the acceptance message is an authorization response.

12. The system of claim 11, wherein initiating the electronic payment transaction includes forwarding the authorization response.

13. The system of claim 9, wherein the proposed interchange fee is determined by artificial intelligence using a machine learning model.

14. The system of claim 9, wherein
the fee request further includes a transaction amount, and
determining the fee rate for each of the plurality of alternative currencies is further based on an equivalent transaction amount for the respective alternative currency based on the transaction amount and an exchange rate with the respective alternative currency.

15. The system of claim 9, wherein the cross-border transaction involves two fiat currencies and each of the plurality of alternative currencies is a cryptographic currency.

16. The system of claim 9, wherein the fee rate for each of the plurality of alternative currencies is determined in real-time.
